(19) United States
(12) Patent Application Publication
(10) Pub. No.: US 2008/0175651 A1
(43) Pub. Date: Jul. 24, 2008

(54) Ring Binder Mechanism with Transverse Actuator

(75) Inventor: Hung Yu Cheng, Hong Kong (CN)

Correspondence Address: SENNIGER POWERS LLP, ONE METROPOLITAN SQUARE, 16TH FLOOR, ST LOUIS, MO, 63102, US

(73) Assignee: WORLD WIDE STATIONERY MFG. CO., LTD., Hong Kong (CN)

(21) Appl. No.: 11/624,554

(22) Filed: Jan. 18, 2007

(51) Int. Cl. B42F 13/20

(52) U.S. Cl. 402/31

(57) ABSTRACT

A ring mechanism for holding loose-leaf pages has an elongate housing and at least two rings for holding the loose-leaf pages. Each ring includes a first ring member and a second ring member, with the first ring member being movable relative to the housing between a closed position and an open position of the rings. An actuator is pivotable relative to the housing on a pivot axis that is parallel to or coaxial with a longitudinal axis of the housing and is operatively connected to the ring members for opening and closing the rings. A locking system is positionable relative to the housing between a locked position in which the ring members are held in the closed position of the rings and an unlocked position. The actuator is also operatively connected to the locking system for positioning the locking system between its locked and unlocked positions.

### BACKGROUND

This invention relates to a ring binder mechanism for retaining loose-leaf pages, and in particular to a ring binder mechanism having an actuator that is operable to open and close the rings of the ring mechanism.

A ring binder mechanism retains loose-leaf pages, such as hole-punched pages, in a file or notebook. It has ring members for retaining the pages. The ring members may be selectively opened to add or remove pages or closed to retain pages while allowing the pages to be moved along the ring members. The ring members mount on two adjacent hinge plates that join together about a pivot axis. An elongate housing loosely supports the hinge plates within the housing and holds the hinge plates together so they may pivot relative to the housing.

The undeformed housing is slightly narrower than the joined hinge plates when the hinge plates are in a coplanar position (180°). So as the hinge plates pivot through this position, they deform the resilient housing and cause a spring force in the housing that urges the hinge plates to pivot away from the coplanar position, either opening or closing the ring members. Thus, when the ring members are closed the spring force resists hinge plate movement and clamps the ring members together. Similarly, when the ring members are open, the spring force holds them apart. An operator may typically overcome this force by manually pulling the ring members apart or pushing them together. Levers may also be provided on one or both ends of the housing for moving the ring members between the open and closed positions.

One drawback to such ring binder mechanisms is that when the ring members are closed, they do not positively lock together. So if the mechanism is accidentally dropped, the ring members may unintentionally open. To this end, ring binder mechanisms have been modified to include locking structure to block the hinge plates from pivoting when the ring members are closed. The blocking structure positively locks the closed ring members together, preventing them from unintentionally opening if the ring mechanism is accidentally dropped. The blocking structure also allows the housing spring force to be reduced because the strong spring force is not required to clamp the closed ring members together. Thus, less operator force is required to open and close the ring members of these mechanisms than in traditional ring mechanisms.

Some of these ring mechanisms, for example, incorporate the locking structure onto a control slide connected to the lever. The lever moves the control slide (and its locking structure) to either block the pivoting movement of the hinge plates or allow it. But a drawback to these mechanisms is that an operator must positively move the lever after closing the ring members to position the locking structure to block the hinge plates and lock the ring members closed. Failure to do this could allow the hinge plates to inadvertently pivot and open the ring members, especially if the mechanisms are accidentally dropped.

Some locking ring binder mechanisms use springs to move the locking structure into position blocking the hinge plates when the ring members close. Examples are shown in co-assigned U.S. patent application Ser. No. 10/870,801 (Cheng et al.), Ser. No. 10/905,606 (Cheng), and Ser. No. 11/027,550 (Cheng). These mechanisms employ separate springs to help lock the mechanisms.

Movement of the locking structure is generally linear or translational, but the actuator is moved by pivoting a lever. Accordingly, such a lever is typically moveable at least in part longitudinally of the ring mechanism, i.e., at least in part in the direction of movement of the locking structure. However, there is a need to accomplish the transmission of motion with a lever that instead moves solely in a direction transverse to the locking structure.

### SUMMARY

In one embodiment, a ring mechanism for holding loose-leaf pages generally comprises an elongate housing having a longitudinal axis, and at least two rings for holding the loose-leaf pages. Each ring includes a first ring member and a second ring member, with the first ring member being movable relative to the housing and the second ring member between a closed position and an open position of the rings. In the closed position the first and second ring members form a substantially continuous, closed loop for allowing loose-leaf pages retained by the rings to be moved along the rings from one ring member to the other, and in the open position the first and second ring members form a discontinuous, open loop for adding or removing loose-leaf pages from the rings.

An actuation system for moving the ring members between the closed and open positions generally comprises elongate first and second hinge members pivotable relative to the housing between a first position corresponding to the closed position of the rings and a second position corresponding to the open position of the rings. The first ring members are operatively connected to the first hinge member for conjoint pivoting movement with the first hinge member between the closed and open positions of the rings. An actuator is pivotable relative to the housing on a pivot axis that is one of parallel to and coaxial with the longitudinal axis of the housing to selectively pivot the hinge members between their first and second positions corresponding to the closed and open positions of the rings.

A locking system of the ring mechanism is positionable relative to the housing between a locked position in which the ring members are held in the closed position of the rings and an unlocked position in which the ring members are moveable from the closed position to the open position of the rings. The locking system is operatively connected to the actuator for operative movement by the actuator between the locked and unlocked positions of the locking system.

In another embodiment, a ring mechanism for holding loose-leaf pages generally comprises an elongate housing having a longitudinal axis, and at least two rings for holding the loose-leaf pages. Each ring includes a first ring member and a second ring member, with the first ring member being movable relative to the housing and the second ring member between a closed position and an open position of the rings. In the closed position the first and second ring members form a substantially continuous, closed loop for allowing loose-leaf pages retained by the rings to be moved along the rings from one ring member to the other, and in the open position the first and second ring members form a discontinuous, open loop for adding or removing loose-leaf pages from the rings.

An actuator of the ring mechanism is pivotable relative to the housing on a pivot axis that is one of parallel to and coaxial with the longitudinal axis of the housing. The actuator is operatively connected to the ring members for selectively moving the ring members between their first and second positions corresponding respectively to the closed and open positions of the rings. A locking system is positionable relative to the housing between a locked position in which the ring members are held in the closed position of the rings and an unlocked position in which the ring members are moveable from the closed position to the open position of said rings. The actuator is further operatively connected to the locking system for positioning the locking system between its locked and unlocked positions.

Other features of the invention will be in part apparent and in part pointed out hereinafter.

### BRIEF DESCRIPTION OF THE DRAWINGS

FIG. 1 is a perspective of a notebook incorporating a ring mechanism according to one embodiment;

FIG. 2 is a bottom perspective of the ring mechanism of FIG. 1 with rings of the ring mechanism illustrated in a closed position and a locking system in a locked position;

FIG. 3 is an exploded top perspective of the ring mechanism of FIG. 1;

FIG. 4 is an enlarged top perspective of one longitudinal end of the ring mechanism of FIG. 1 with portions of a housing of the ring mechanism cut away to reveal internal construction;

FIG. 5A is an enlarged plan of the longitudinal end shown in FIG. 4, with the ring mechanism illustrated in a closed position;

FIG. 5B is a view similar to FIG. 5A with the ring mechanism illustrated in an open position;

FIG. 6A is a section taken adjacent the longitudinal end shown in FIG. 4, with the ring mechanism illustrated in a closed position;

FIG. 6B is a view similar to FIG. 6A with the ring mechanism illustrated in an open position;

FIG. 7 is a top perspective of the ring mechanism of FIG. 1 with the rings of the ring mechanism illustrated in an open position and the locking system in an unlocked position;

FIG. 8 is a bottom perspective of the ring mechanism of FIG. 1 with the rings of the ring mechanism illustrated in an open position and the locking system in an unlocked position;

FIG. 9 is a view similar to FIG. 4 with the ring mechanism illustrated in an open position and the locking system in an unlocked position; and

FIG. 10 is a top perspective of a ring mechanism according to another embodiment.

Corresponding reference numbers indicate corresponding parts throughout the views of the drawings.

### DETAILED DESCRIPTION

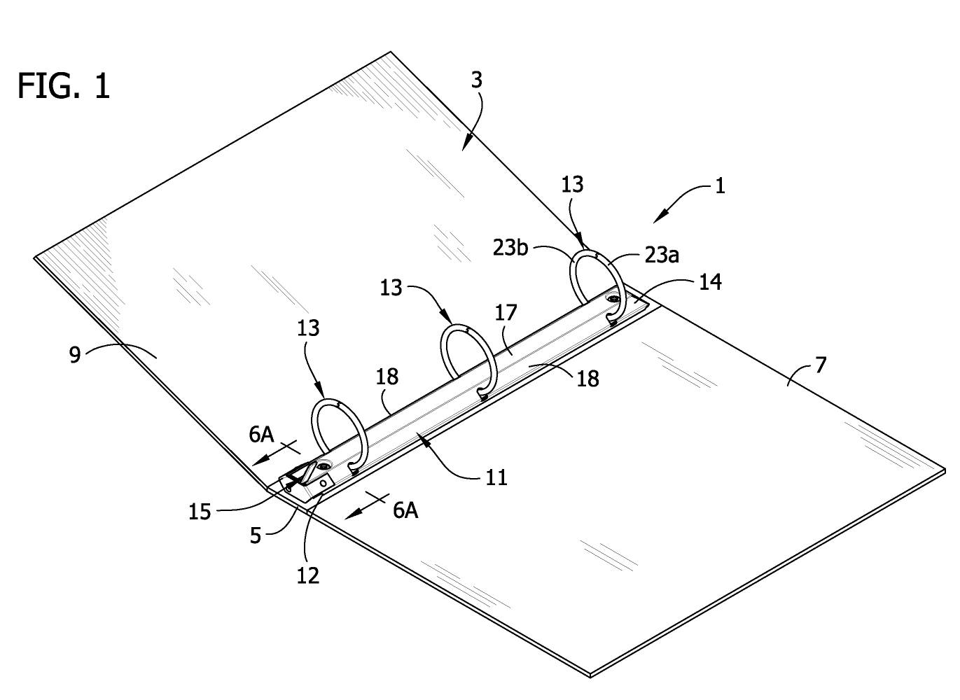

Referring now to the drawings, and in particular to FIG. 1, a ring binder mechanism (also broadly referred to herein as a ring mechanism) according to one embodiment is generally indicated at 1 and illustrated as being suitably mounted a notebook, designated generally at 3. Specifically, the ring mechanism 1 is shown mounted on a spine 5 of the notebook 3 between a front cover 7 and a back cover 9 hinged to the spine 3. The front and back covers 7, 9 move to selectively cover or expose loose-leaf pages (not shown) retained by the ring mechanism 1 in the notebook 3. It is understood, though, that the ring mechanism 1 may be mounted on notebooks in ways other than shown in FIG. 1, or on surfaces or structures other than a notebook, for example, a file, without departing from the scope of this invention.

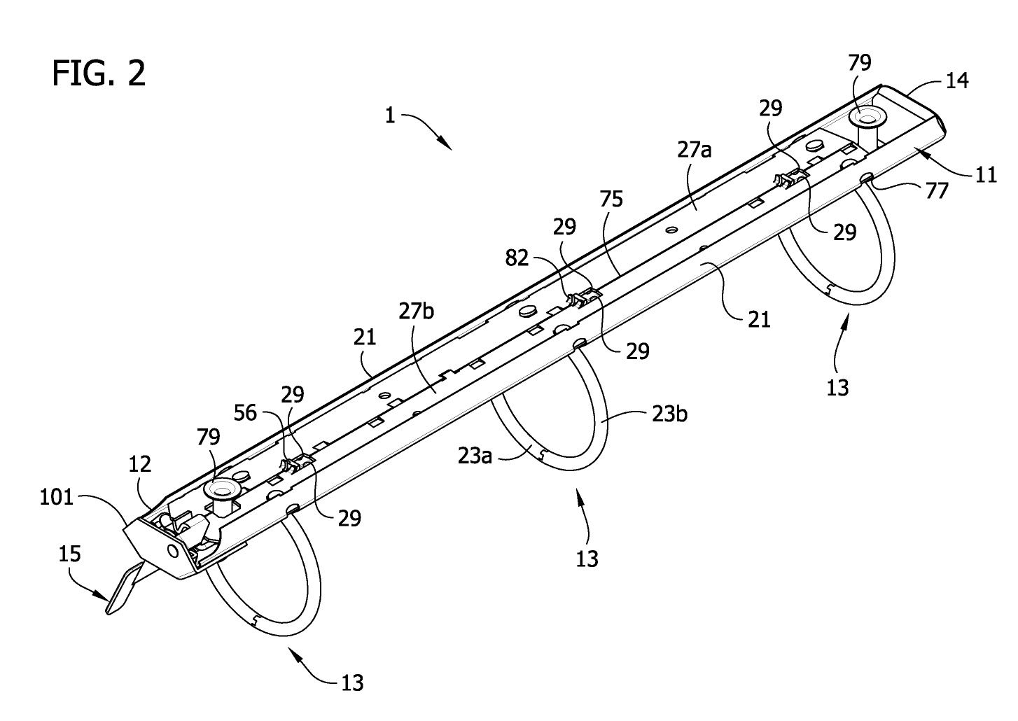

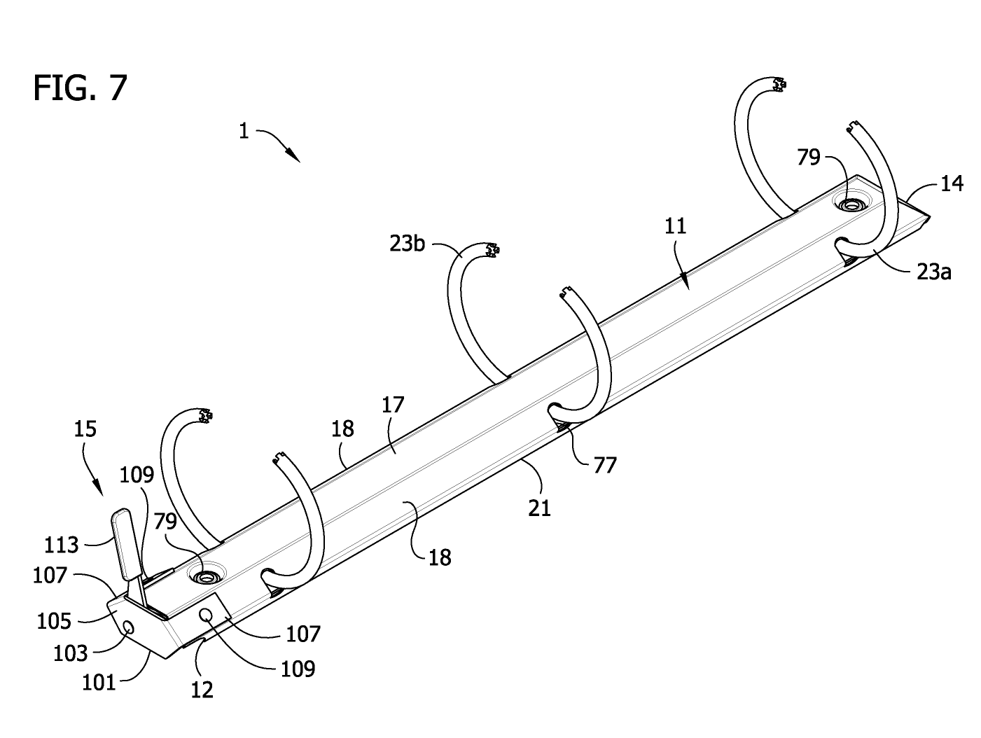

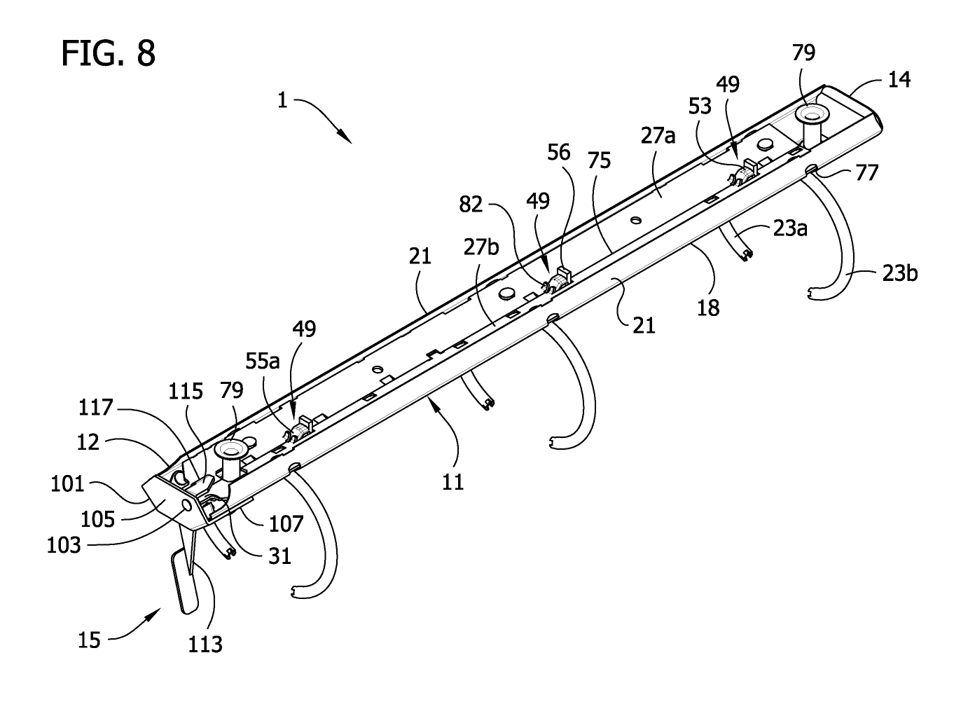

In the illustrated embodiment of FIG. 1, the ring mechanism 1 generally comprises a housing, designated generally at 11, at least two rings (three such rings are illustrated in FIG. 1 and designated generally at 13) spaced longitudinally from each other along the housing, and a lever (broadly, an “actuator,” and designated generally at 15). The rings 13 retain loose-leaf pages on the ring mechanism 1 in the notebook 3 while the lever 15 is operable to move the rings between a closed position (FIGS. 1 and 2) and an open position (FIGS. 7 and 8) so that pages may be added or removed from the ring mechanism.

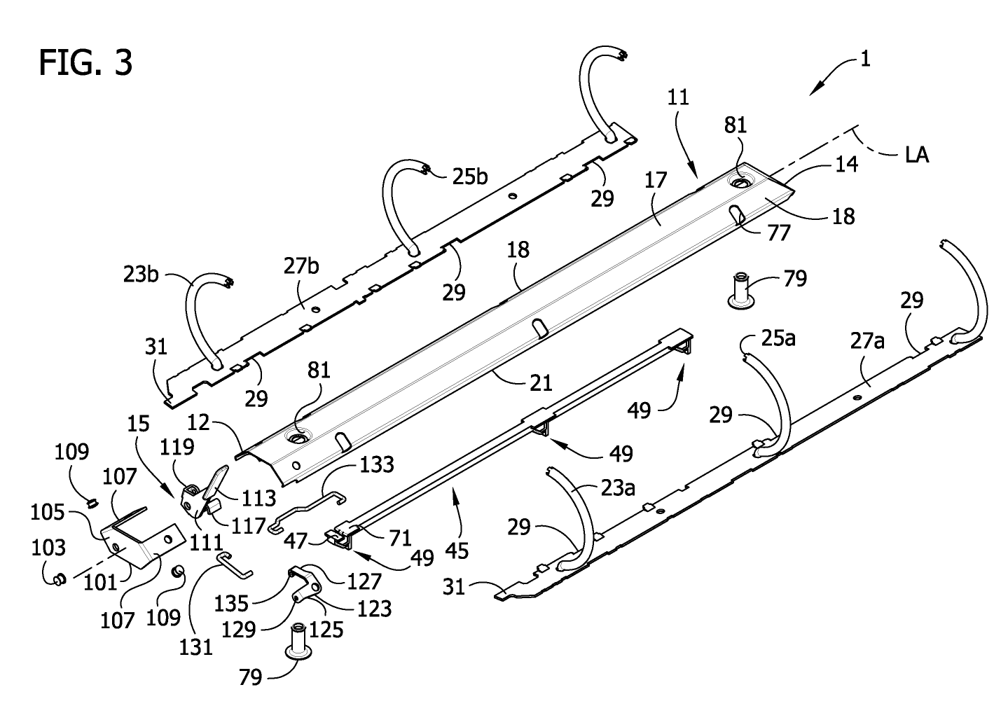

The housing 11 (with more particular reference to FIG. 3, is generally elongate, having a longitudinal axis LA and longitudinally opposite ends 12, 14. One end 12 of the housing 11 (to the left in FIG. 2) is generally open while the other end 14 is generally closed. The illustrated housing 11 has a generally uniform cross-section along its length including a central, generally flat longitudinally extending top wall 17 and laterally opposite, longitudinally extending side walls 18 formed integrally with and angled laterally outward from the top wall so that the cross-section of the housing is roughly arch-shaped. Bent under rims, each designated at 21 (FIG. 2), extend lengthwise along longitudinal edges of the side walls along the entire length of the housing 11. It is understood that the housing 11 may be shaped other than as illustrated, including being of an irregular shape. In addition, while the illustrated housing 11 is formed separate from and secured to the notebook 3, it is contemplated that the housing may be formed integral with a file or notebook without departing from the scope of this invention.

The rings 13 of the ring mechanism 1 are of substantially similar construction, with each ring being generally circular in shape (e.g., FIG. 1). As shown in FIGS. 1 and 2, each of the rings 13 comprises a pair of generally semi-circular ring members (broadly, a first ring member 23a, and a second ring member 23b) formed from a conventional, cylindrical rod of a suitable material (e.g., steel). The ring members 23a, 23b include mating free ends 25a, 25b (FIG. 3), respectively, formed to secure the ring members against misalignment relative to each other in the closed position of the rings (see FIG. 1). The rings 13 may alternatively be D-shaped as is known in the art, or otherwise suitably shaped within the scope of this invention. Ring mechanisms with ring members formed other than of steel, and/or having different cross-sectional shapes, for example, ovate, do not depart from the scope of this invention.

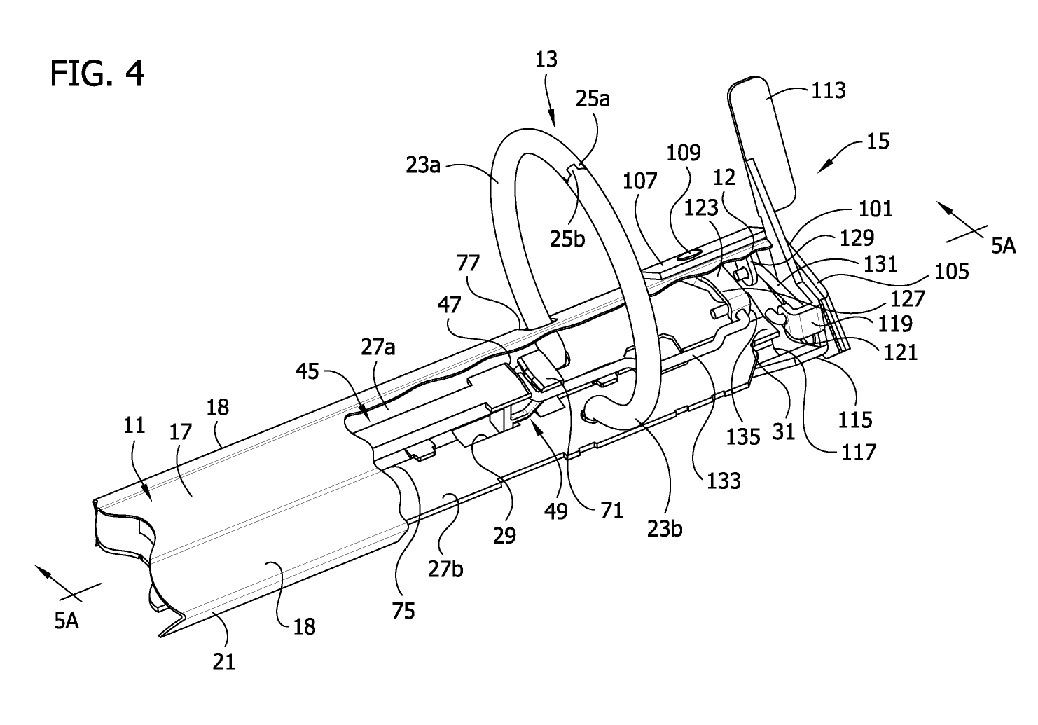

As also shown in FIG. 2, the ring mechanism 1 includes a pair of substantially identical hinge members (broadly, a first hinge member 27a and second hinge member 27b), supporting the respective ring members 23a, 23b. These hinge plates 27a, 27b, together with the lever 15, broadly define an actuation system for actuating the ring members 23a, 23b between the open and closed positions of the rings. In the illustrated embodiment the hinge members 27a, 27b are suitably in the form of hinge plates, each of which is generally elongate, flat, and rectangular in shape and somewhat shorter in length than the housing 11. As shown in FIGS. 2 and 4, the hinge plates 27a, 27b are interconnected in parallel arrangement along their laterally inner edge margins to together form a central hinge 75 that defines a pivot axis extending parallel to or coaxial with the longitudinal axis LA (FIG. 3) of the housing. This is done in a conventional manner known in the art. Hinging the hinge plates 27a, 27b together in this manner allows the plates to pivot relative to each other about the pivot axis of the hinge 75 between a first position (FIG. 2) that corresponds to the closed position of the rings 13 (and hence of the ring mechanism 1) and a second position (FIG. 8) that corresponds to the open position of the rings.

The housing 11 suitably supports the interconnected (i.e., hinged) hinge plates 27a, 27b within the housing. The laterally outer edge margins of the hinge plates 27a, 27b loosely fit behind the bent under rims 21 of the housing 11 for allowing the hinge plates to move within the rims when the hinge plates pivot. With reference back to FIG. 2, the ring members 23a, 23b are respectively mounted on the upper surfaces of the hinge plates 27a, 27b in generally opposed fashion, with the free ends 25a, 25b facing each other in the closed position of the rings 13. As seen best in FIGS. 3 and 7, the ring members 23a, 23b extend through respective openings 77 formed in the side walls 18 of the housing so that the free ends 25a, 25b of the ring members can engage above (i.e., exterior of) the housing.

The ring members 23a, 23b are rigidly connected to the hinge plates 27a, 27b as is known in the art for conjoint movement with the hinge plates upon pivoting of the hinge plates between their first and second positions. Although the illustrated ring members 23a, 23b are each mounted on one of the two hinge plates 27a, 27b for pivoting movement with the hinge plates, a ring mechanism 1 in which each ring 13 comprises one movable ring member and one fixed ring member does not depart from the scope of this invention (e.g., a ring mechanism in which only one of the ring members of each ring is mounted on a hinge plate with the other ring member mounted on stationary structure such as the housing).

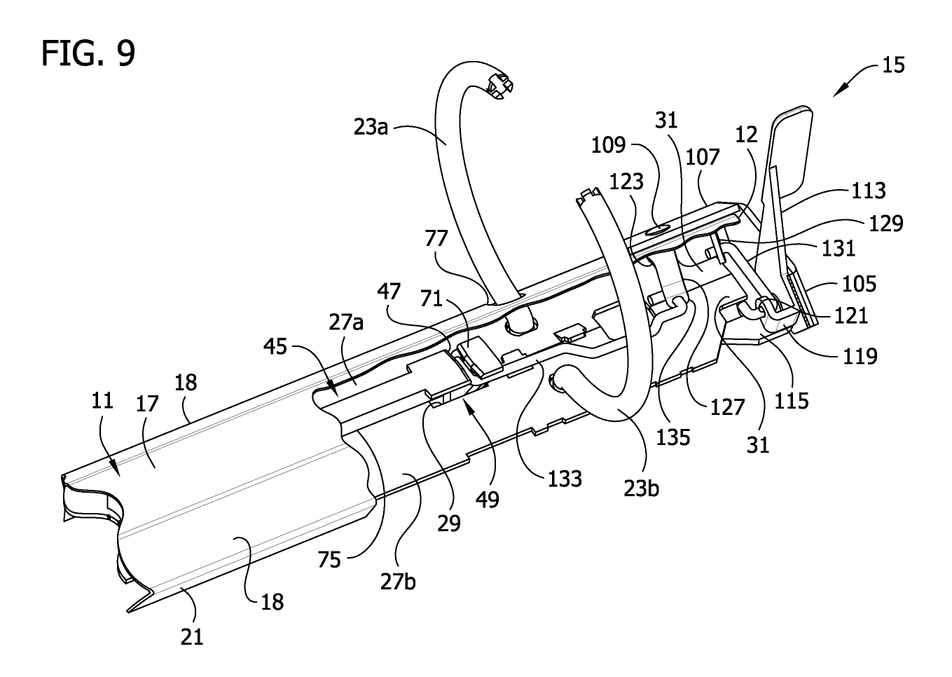

Cutouts 29 are formed in each of the hinge plates 27a, 27b along the respective inner edge margins of the plates such that upon adjacent or abutting (e.g., side-by-side) alignment of the plates, and more particularly when the plates are hinged together, the cutouts of the plates together form openings in the hinge 75 as shown in FIG. 2. A finger 31 (FIGS. 3 and 9) extends longitudinally away from the longitudinal end of each hinge plate 27a, 27b (e.g., to the left in FIG. 3). The fingers 31 are each narrower in width than the respective hinge plates 27a, 27b and are positioned with their inner longitudinal edges generally aligned with the inner longitudinal edges of the plates. As shown in FIGS. 2-4, the fingers 31 of the hinge plates 27a, 27b are disposed adjacent the longitudinal end of the housing 11 at which the lever 15 is located.

As shown in FIG. 2, a pair of longitudinally spaced mounting posts 79 are secured to the housing 11 to mount the ring mechanism 1 on the notebook 3 (FIG. 1). The posts 79 attach to the housing 11 at mounting post openings 81 (FIG. 3) formed in the top wall 17 of the housing 11 toward the longitudinally opposite ends 12, 14 of the housing.

The ring mechanism 1 further comprises a suitable locking system, which in the illustrated embodiment comprises an elongate travel bar, designated generally at 45 (FIG. 3), selectively positionable between an unlocked position and a locked position for holding the rings 13 in their closed position to prevent inadvertent opening of the rings. The travel bar 45 is suitably located between the top wall 17 of the housing 11 and the hinge 75 generally longitudinally along the hinge 75 between the hinge plates 27a, 27b. The travel bar 45 has a mounting groove 47 located at a first longitudinal end thereof (e.g., to the left in FIG. 3, toward the end of the housing 11 at which the lever is located) and defining a tab 71 at the end of the travel bar, and three locking elements (each designated generally at 49) along the underside of the travel bar. The locking elements 49 are spaced apart longitudinally along the travel bar 45 with one locking element adjacent each longitudinal end of the travel bar, and one located toward a longitudinal center of the travel bar. The locking elements 49 are particularly spaced from each other in accordance with the longitudinal spacing between the openings formed by the cutouts 29 in the hinge plates 27a, 27b. It is understood that the travel bar 45 may be shaped other than as illustrated in FIG. 2 and/or have greater or fewer than three locking elements 49 without departing from the scope of this invention.

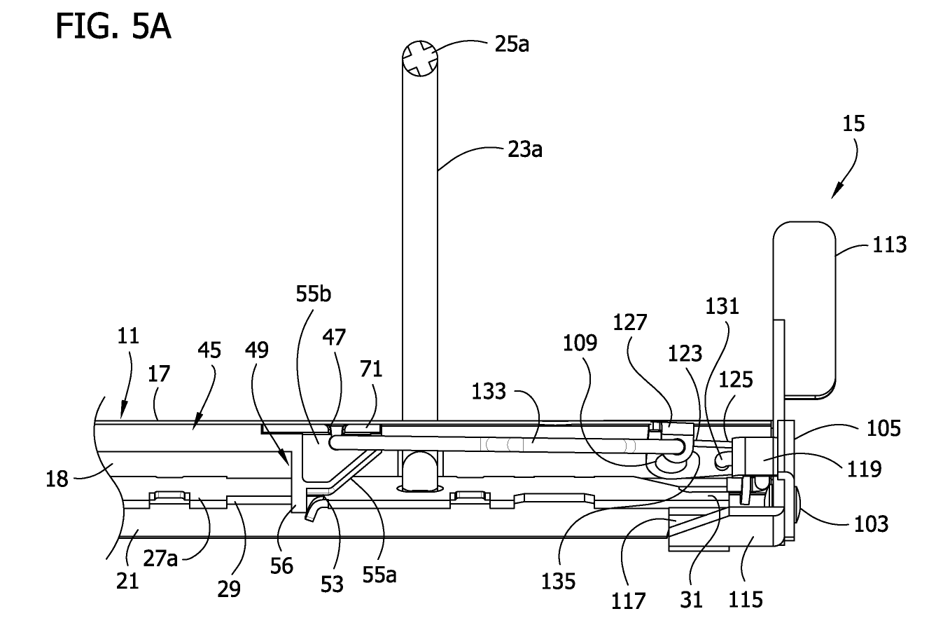

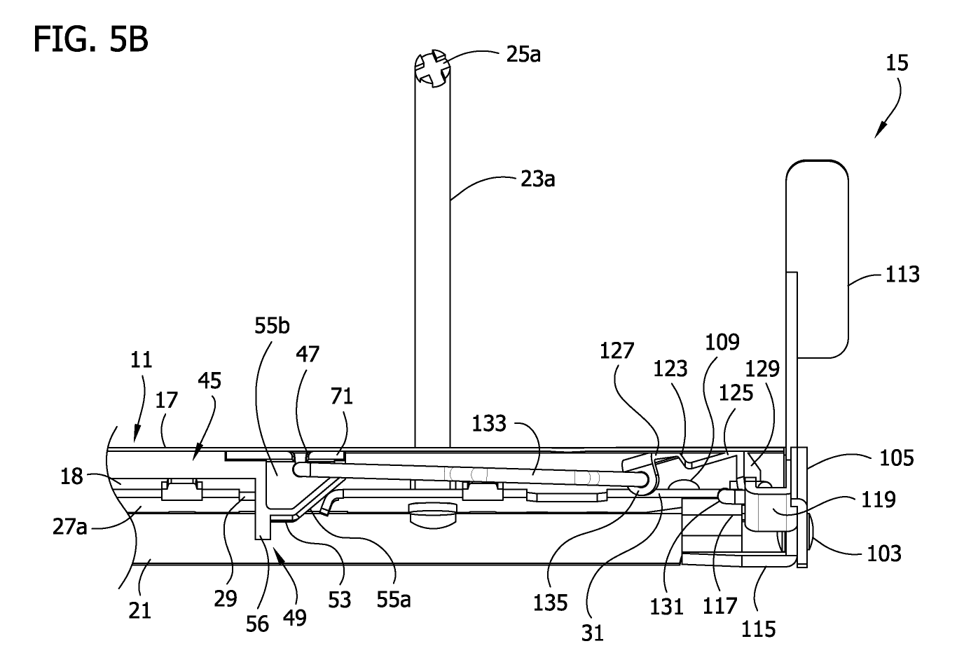

The locking elements 49 of the illustrated travel bar 45 are each substantially similar in shape. As shown in FIGS. 5A and 5B, each locking element 49 includes a narrow, flat bottom 53, an angled forward edge 55a, recessed lateral sides 55b (only one side is visible), and a rearward extension 56 so that the locking elements are each generally wedge-shaped. As described in further detail later herein, the angled edges 55a of the locking elements 49 are engageable with the hinge plates 27a, 27b along the hinge line therebetween to assist in pivoting the hinge plates down (e.g., from the second position of the hinge plates corresponding to the open position of the rings to the first position of the hinge plates corresponding to the closed position of the rings). In the illustrated embodiment, the locking elements 49 are formed integrally with the travel bar 45 by, for example, a mold process. However, it is contemplated that the locking elements 49 may instead be formed separate from the travel bar 45 and attached thereto without departing from the scope of the invention. It is also contemplated that the locking elements 49 may be shaped other than as illustrated, such as block-shaped (e.g., having no angled edges and/or recessed sides).

With particular reference now to FIGS. 2-4, 5A, 5B, 6A and 6B, the lever 15 broadly defines an actuator that is operable, and more suitably pivotable, between a first position (FIGS. 4, 5A, 5B) and a second position (FIGS. 5B, 6B and 7) angularly offset from the first position to move the hinge plates 27a, 27b between their first and second positions so as to open and close the rings 13. The lever 15 is pivotally mounted on a suitable mounting bracket 101 by a rivet (broadly, a pivot pin 103) that allows pivoting movement of the lever about a pivot axis defined by the pivot pin. In this manner, the pivot axis of the lever 15 is thus suitably parallel to or coaxial with the longitudinal axis LA of the housing 11. As best seen in FIG. 3, the mounting bracket 101 is generally U-shaped, having a back panel 105 to which the lever 15 is pivotally mounted by the pivot pin 103, and a pair of laterally spaced arms 107 extending out from the back panel to overly the side walls 18 of the housing 11. The mounting bracket 101 is fastened to the housing 11 by suitable rivets 109 or fastener pins that secure the overlying arms 107 to the housing side walls 18 such that the back panel 105 of the mounting bracket generally closes the open end 12 of the housing 11.

The illustrated lever 15 suitably comprises a central plate member 111 (FIG. 3)(through which the pivot pin 103 passes to mount the lever on the mounting bracket 101) having an elongate grip 113 formed integrally therewith and extending generally up from the central plate member between the back panel 105 and the open end 12 of the housing 11 so that the grip is accessible for grasping the grip to move the lever. It is understood, though, that the grip 113 may be other than elongate, and may be shaped other than as illustrated (e.g., the grip may be more wheel or disc-shaped and need not actually be configured for grasping between two fingers) without departing from the scope of this invention. A flange member 115 (see FIGS. 4, 5A and 5B) extends longitudinally outward from (e.g., out of the plane of) the central plate member 111 of the lever 15 and has a foot 117 (broadly, a contact member) extending transversely from the end of the flange member. The flange member 115 is particularly located and configured relative to the central plate member 111 so that the foot 117 is spaced (e.g., radially) from the pivot axis defined by the pivot pin 103 of the lever for movement relative to the housing 11 and hinge plates 27a, 27b upon pivoting the lever.

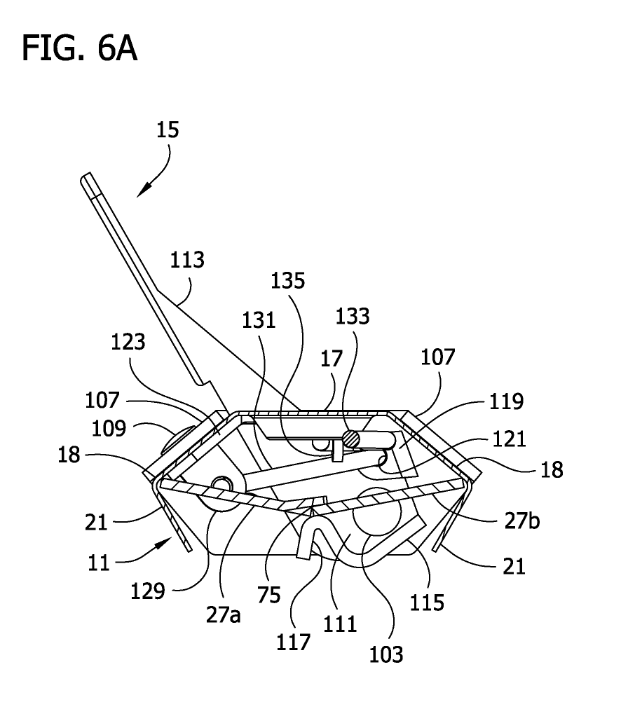

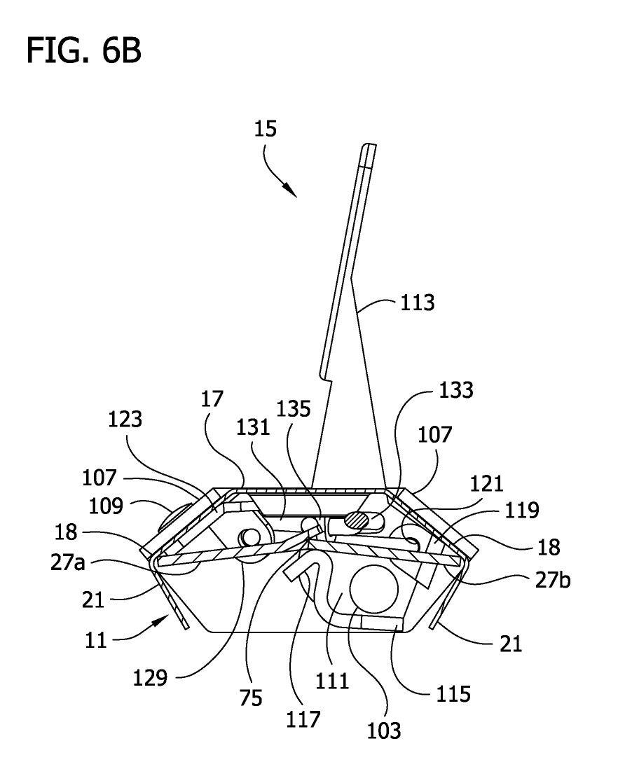

As best seen in FIGS. 2 and 6A, in the first position of the lever 15 and hinge plates 27a, 27b corresponding to the closed position of the rings 13 the lever foot 117 is disposed in abutting contact with the hinge plates 27a, 27b at the hinge 75 therebetween. Alternatively, the foot 117 may be spaced from the fingers 31 in the first position of lever 15 and hinge plates 27a, 27b. The path of movement of the foot 117 relative to the pivot pin 103 is such that upon pivoting the lever 115 the foot moves upward relative to the fingers 31 and housing 11 to urge the hinge plates 27a, 27b to pivot to their second position corresponding to the open position (FIG. 6A) of the rings 13 to thereby open the rings.

The lever 15 further comprises a connection flange 119 formed integrally with the central plate member 111 and extending longitudinally outward therefrom (i.e., out of the plane of the central plate member). An opening 121 is formed in the connection flange 119 for use in operatively connecting together the lever 15 and the travel bar 45 such that pivoting movement of the lever effects translational, and more particularly longitudinal movement of the travel bar, and vice-versa. In the illustrated embodiment, for example, a generally L-shaped pivot link 123 is pivotally mounted on the housing 11, and more suitably on the underside of one side wall 18 of the housing, such as by the rivet 109 used to secure the mounting bracket 101 to the housing side wall. The pivot link 123 is suitably oriented relative to the housing 11 such that a longitudinal segment 125 of the pivot link extends generally longitudinally of the housing and a transverse segment 127 of the pivot link extends transversely inward relative to the housing side wall 18 to a position generally above the hinge 75 interconnecting the hinge plates 27a, 27b. The pivot link 123 is pivotally mounted on the housing side wall 18 at the intersection of the longitudinal segment 125 and the transverse segment 127 of the pivot link.

A free end 129 of the longitudinal segment 125 of the pivot link 123 is operatively connected to the connection flange 119 of the lever 15 by a suitable lever connector 131 so as to operatively connect the pivot link with the lever. The lever connector 131 of the illustrated embodiment is suitably a wire that extends at one end through the opening 121 in the connection flange 119 and at its opposite end through an opening in the free end 129 of the longitudinal segment 125 of the pivot link 123.

An intermediate connector 133 operatively connects a free end 135 of the transverse segment 127 of the pivot link 123 with the longitudinal end of the travel bar 45 to thereby operatively connect the travel bar with the pivot link, and hence with the lever 15 via the lever connector 131. In the illustrated embodiment, the intermediate connector 133 comprises an elongate wire that extends at one end through an opening formed in the free end 135 of the transverse segment 127 of the pivot link 123. The opposite end of the wire (i.e., intermediate connector 133) is bent generally at a right angle and seats within the mounting groove 47 formed in part by the tab 71 at longitudinal end of the travel bar 45. The tab 71 prevents the intermediate connector 133 from inadvertently popping out of the groove 47 and allows the connector to either push against the travel bar 45 or pull on the travel bar depending on the direction of longitudinal movement of the travel bar. The intermediate connector 133 can also pivot relative to the travel bar 45 within the groove 47 to accommodate vertical motion of the intermediate connector that results from the pivot link 123 being angled in accordance with the side wall 18 of the housing 11 (e.g., such that the free end 135 of the transverse segment 127 changes heights upon pivoting.

It is understood that the travel bar 45 may be operatively connected to the lever 15 other than as described above without departing from the scope of this invention, as long as the lever is pivotable on a pivot axis that is parallel to or coaxial with the longitudinal axis LA of the housing 11 and such pivoting movement operates to open and close the rings 13.

In setting forth details of operation of the ring mechanism 1, FIGS. 1, 2, 4, 5A and 6A are referred to as illustrating the ring mechanism with the rings 13 in their closed position. In particular, the hinge plates 27a, 27b are hinged downward (e.g., along the hinge 75) to their first position, away from the top wall 17 of the housing 11, so that the ring members 23a, 23b of each ring 13 are together (e.g., in the closed position of the ring) in a continuous, circular loop, capable of retaining loose-leaf pages. The lever 15 is also in a first position corresponding to the closed position of the rings 13, with the lever grip 113 angled toward one side of the housing 11. In this position, the lever foot 117 (i.e., the contact member) abuts against the fingers 31 of the hinge plates 27a, 27b along the hinge 75 as seen best in FIG. 6A.

The travel bar 45 (i.e., the locking system of the ring mechanism 1) is in what is referred to herein as a locked position with the locking elements 49 of the travel bar positioned longitudinally adjacent the respective openings formed by the cutouts 29 of the hinge plates 27a, 27b along the hinge 75. The locking elements 49 are substantially out of registration with these hinge 75 openings such that the flat bottom surfaces 53 of the locking elements rest against the upper surfaces of the hinge plates 27a, 27b and the rearward extensions 56 extend down through the respective openings adjacent forward, downturned tabs 82 of the plates. Together, the travel bar 45 and locking elements 49 oppose any force tending to pivot the hinge plates 27a, 27b upward to open the ring members 23a, 23b (i.e., they lock the ring members closed).

With reference to FIGS. 5B and 6B, to unlock the ring mechanism 1 and open the ring members 23a, 23b, a pivoting force is applied to the grip 113 of the lever 15 to pivot the lever about its pivot axis (e.g., defined by the pivot pin 103) relative to the housing 11 to the second position (FIG. 6B) of the lever. Upon pivoting movement of the lever 15, the connection flange 119 generally orbits the lever pivot axis along an arcuate path such that the connection flange pulls the lever connector 131, and hence the free end 129 of the longitudinal segment 125 of the pivot link 123, to pivot the pivot link about its respective pivot axis defined by the rivet 109. The free end 135 of the transverse segment 127 of the pivot link 123, upon pivoting of the pivot link, moves generally longitudinally relative to the housing 11 and hinge plates 27a, 27b. As a result, the intermediate connector 133, via its connection with both the transverse segment 127 of the pivot link 123 and the longitudinal end of the travel bar 45, pushes the travel bar to slide longitudinally relative to the housing 11 (e.g., longitudinally away from the lever 15, or to left in the illustrated embodiment of FIG. 5B) to an unlocked position of the travel bar in which the locking elements 49 are generally aligned with the openings formed along the hinge 75 by the hinge plate cutouts 29 as illustrated in FIGS. 5B and 8.

Also upon pivoting the lever 15 toward its second position, the lever foot 117 is moved by the central plate member 111 of the lever generally upward relative to the housing 11 and hinge plates 27a, 27b against the fingers 31. The foot 117 thus urges the hinge plates 27a, 27b to pivot upward at the hinge 75 over the locking elements 49 at the openings along the hinge so that the locking elements seat within and at least in part extend through the openings formed by the hinge plate cutouts 29. Once the hinge plates 27a, 27b pass just through the co-planar (with each other) position, the housing 11 spring force urges them upward, opening the ring members 23a, 23b (FIGS. 8 and 9). The lever 15 can be released and generally remains in this position, including with the lever foot 117 contacting the fingers 31 of the hinge plates 27a, 27b, until the rings 13 are subsequently closed.

To close the rings 13 and return the locking system (e.g., the travel bar 45) to its locked position, an operator can pivot the lever 15 back toward its first position (FIG. 6A). Pivoting the lever 15 in this direction results in the connection flange 119 moving at least in part transversely toward the housing side wall 18 on which the pivot link 123 is mounted, thereby pivoting (e.g., via the lever connector 131 connected to the free end 129 of the longitudinal segment 125 of the pivot link) the pivot link relative to the housing 11 and hinge plates 27a, 27b. Upon pivoting the pivot link 123, the free end 135 of the transverse segment 127 of the pivot link moves generally longitudinally toward the lever 15 (e.g., to the right in FIG. 5A), thereby pulling the travel bar 45 to its locked position.

As the travel bar 45 is pulled longitudinally relative to the hinge plates 27a, 27b, the angled forward edges 55a of the locking elements 49 engage the hinge plates at the openings formed by the cutouts 29 to urge the hinge plates down (e.g., at the hinge 75) to the first position of the hinge plates. Because the ring members 23a, 23b are operatively connected (and more particularly mounted on in the illustrated embodiment) to the hinge plates 27a, 27b, the ring members are moved to the closed position of the rings 13 upon movement of the hinge plates to their first position.

In an alternative method of closing the rings 13, an operator can simply urge the ring members 23a, 23b together (e.g., without touching the lever 15). Urging the ring members 23a, 23b together in this manner operatively urges the hinge plates 27a, 27b downward to their first position. As the hinge plates 27a, 27b are moved downward, the fingers 31 of the hinge plates push against the lever foot, thereby rotating the lever to its first position. Pivoting the lever 15 causes the connection flange 119 to move, thereby pivoting the pivot link 123 as described above to pull the travel bar 45 to its locked position.

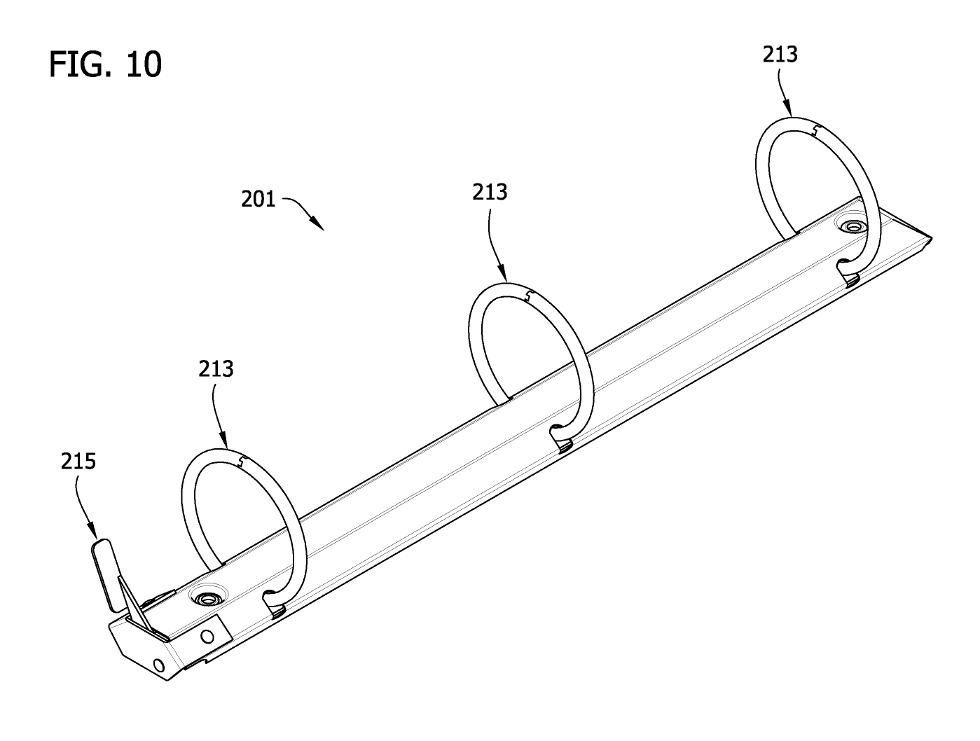

FIG. 10 illustrates an alternative embodiment of a suitable ring mechanism 201 in which the lever 215 is pivotable from its first to its second position (e.g., so as to open the rings 213) in a direction opposite the direction of pivoting movement of the lever 15 of FIGS. 1-9 to open the rings 13 of the ring mechanism 1.

The various components of ring binder mechanism 1 of the embodiments described and illustrated herein are made of a suitable rigid material, such as a metal (e.g. steel). However, it is understood that mechanisms having one or more components made of a nonmetallic material, specifically including a plastic, do not depart from the scope of this invention.

When introducing elements of the ring binder mechanisms herein, the articles “a”, “an”, “the” and “said” are intended to mean that there are one or more of the elements. The terms “comprising”, “including” and “having” and variations thereof are intended to be inclusive and mean that there may be additional elements other than the listed elements.

As various changes could be made in the above without departing from the scope of the invention, it is intended that all matter contained in the above description and shown in the accompanying drawings shall be interpreted as illustrative and not in a limiting sense.

What is claimed is:

1. A ring mechanism for holding loose-leaf pages, the ring mechanism comprising:
an elongate housing having a longitudinal axis;
at least two rings for holding the loose-leaf pages, each ring including a first ring member and a second ring member, the first ring member being movable relative to the housing and the second ring member between a closed position and an open position of said rings, in the closed position the first and second ring members forming a substantially continuous, closed loop for allowing loose-leaf pages retained by the rings to be moved along the rings from one ring member to the other, and in the open position the first and second ring members forming a discontinuous, open loop for adding or removing loose-leaf pages from the rings;
an actuation system for moving the ring members between the closed and open positions, the actuation system comprising elongate first and second hinge members pivotable relative to the housing between a first position corresponding to the closed position of the rings and a second position corresponding to the open position of the rings, said first ring members being operatively connected to the first hinge member for conjoint pivoting movement with the first hinge member between the closed and open positions of the rings, and an actuator pivotable relative to the housing on a pivot axis that is one of parallel to and coaxial with the longitudinal axis of the housing to selectively pivot the hinge members between their first and second positions corresponding to the closed and open positions of the rings; and
a locking system positionable relative to the housing between a locked position in which the ring members are held in the closed position of the rings and an unlocked position in which the ring members are moveable from the closed position to the open position of said rings, said locking system being operatively connected to the actuator for operative movement by the actuator between the locked and unlocked positions of the locking system.

2. The ring mechanism set forth in claim 1 wherein the locking system comprises an elongate travel bar moveable longitudinally relative to the housing between the locked and unlocked positions of the locking system.

3. The ring mechanism set forth in claim 1 wherein the actuator is engageable with the hinge members in the first position of said hinge members to urge the hinge members from their first position corresponding to the closed position of the rings to their second position corresponding to the open position of the rings.

4. The ring mechanism set forth in claim 3 wherein the locking system is engageable with the hinge members in the second position of said hinge members to urge the hinge members from their second position corresponding to the open position to their first position corresponding to the closed position of the rings.

5. The ring mechanism set forth in claim 4 wherein the locking system comprises an elongate travel bar positionable longitudinally relative to the housing between the locked and unlocked positions of the locking system, said travel bar being engageable with the hinge members upon movement of said travel bar from the unlocked position toward the locked position of the locking system to move the ring members from the closed position to the open position of the rings.

6. The ring mechanism set forth in claim 1 wherein the housing has longitudinally opposite ends, the housing being open at one longitudinal end, the ring mechanism further comprising a mounting bracket fastened to the housing generally at said longitudinal thereof, the actuator being pivotally mounted on the mounting bracket for pivoting movement relative to the mounting bracket and the housing.

7. The ring mechanism set forth in claim 6 wherein the mounting bracket comprises a back panel substantially closing the open longitudinal end of the housing.

8. The ring mechanism set forth in claim 7 wherein the actuator comprises a grip extending at least in part outward from the housing and mounting bracket for accessing the grip to pivot the actuator.

9. The ring mechanism set forth in claim 1 wherein the locking system comprises an elongate travel bar positionable longitudinally relative to the housing between the locked and unlocked positions of the locking system, the ring mechanism further comprising a pivot link operatively connecting the travel bar with the actuator, the pivot link being pivotable relative to the housing and configured such that upon pivoting movement of the actuator the pivot link moves the travel bar longitudinally.

10. The ring mechanism set forth in claim 9 wherein the pivot link is mounted on the housing for pivoting movement relative thereto, the ring mechanism further comprising a connector operatively connecting the pivot link with the actuator such that pivoting movement of the actuator effects pivoting movement of the pivot link relative to the housing.

11. The ring mechanism set forth in claim 9 wherein the pivot link comprises a generally longitudinal segment operatively connected to the actuator for generally transverse movement relative to the housing in response to pivoting movement of the actuator to thereby pivot the pivot link relative to the housing, and a generally transverse segment operatively connected to the travel bar and moveable generally longitudinally relative to the housing upon pivoting of the pivot link to thereby move the travel bar longitudinally.

12. The ring mechanism set forth in claim 11 wherein the pivot link is generally L-shaped, with the longitudinal segment interconnected with the transverse segment, said pivot link being pivotable about a pivot axis extending generally through the interconnection of said longitudinal segment and said transverse segment.

13. The ring mechanism set forth in claim 1 wherein the actuator comprises a central plate member through which the pivot axis of the actuator extends, a grip connected to the central plate member and accessible exterior of the housing for pivoting the actuator, a contact member connected to the central plate member and spaced radially from the pivot axis of the actuator, said contact member extending outward from a plane of the central plate member for engagement with the hinge members upon pivoting movement of the actuator.

14. The ring mechanism set forth in claim 1 wherein the locking system comprises a locking element movable by the actuator between the locked position blocking the pivoting motion of the hinge plates and the unlocked position allowing the pivoting motion of the hinge plates, the locking element in the locked position being free of forces tending to move the locking element from the locked position toward the unlocked position and in the unlocked position being free of forces tending to move the locking element from the unlocked position toward the locked position.

15. The ring mechanism set forth in claim 1 wherein the actuator is a lever.

16. The ring mechanism set forth in claim 1 in combination with a cover, the ring mechanism being mounted on the cover, the cover being hinged for movement to selectively cover and expose loose-leaf pages when retained on the ring mechanism.

17. A ring mechanism for holding loose-leaf pages, the ring mechanism comprising:
an elongate housing having a longitudinal axis;
at least two rings for holding the loose-leaf pages, each ring including a first ring member and a second ring member, the first ring member being movable relative to the housing and the second ring member between a closed position and an open position of said rings, in the closed position the first and second ring members forming a substantially continuous, closed loop for allowing loose-leaf pages retained by the rings to be moved along the rings from one ring member to the other, and in the open position the first and second ring members forming a discontinuous, open loop for adding or removing loose-leaf pages from the rings;
an actuator pivotable relative to the housing on a pivot axis that is one of parallel to and coaxial with the longitudinal axis of the housing, said actuator being operatively connected to the ring members for selectively moving the ring members between their first and second positions corresponding respectively to the closed and open positions of the rings; and
a locking system positionable relative to the housing between a locked position in which the ring members are held in the closed position of the rings and an unlocked position in which the ring members are moveable from the closed position to the open position of said rings, said actuator further being operatively connected to the locking system for positioning the locking system between its locked and unlocked positions.

18. The ring mechanism set forth in claim 17 wherein the actuator is operatively connected to the ring members and to the locking system to move the ring members between their first and second positions concurrently with positioning of the locking system between its locked and unlocked positions upon pivoting movement of the actuator.

19. The ring mechanism set forth in claim 17 wherein the locking system comprises an elongate travel bar moveable longitudinally relative to the housing between the locked and unlocked positions of the locking system.

20. The ring mechanism set forth in claim 19 further comprising a pivot link operatively connecting the travel bar with the actuator, the pivot link being pivotable relative to the housing and configured such that upon pivoting movement of the actuator the pivot link moves the travel bar longitudinally relative to the housing.
